(19) United States
(12) Patent Application Publication
(10) Pub. No.: US 2017/0111964 A1
(43) Pub. Date: Apr. 20, 2017

(54) STEP-UP/STEP-DOWN CONVERTER WITH A PROTECTIVE CIRCUIT

(71) Applicant: Valeo Vision, Bobigny Cedex (FR)

(72) Inventors: Patrick Wacheux, Bois Le Roy (FR); Sebastian Krick, Paris (FR); Kien Lai-Dac, Puteaux (FR); Huy-Cuong Nguyen, Villiers Sur Marne (FR)

(21) Appl. No.: 15/317,529

(22) PCT Filed: Jul. 2, 2015
(86) PCT No.: PCT/EP2015/065104

§ 371 Date: Dec. 9, 2016

(30) Foreign Application Priority Data
Jul. 4, 2014 (FR) 1456491

(51) Int. Cl. H05B 33/08; H02M 3/157; H02M 1/32; H05B 37/02

(52) U.S. Cl. CPC H05B 33/0809; H05B 37/02; H02M 3/157; H02M 1/32

(57) ABSTRACT

A device and a method for protecting the buck circuit of a DC voltage converter, for example of boost-buck type, if the input voltage of the boost circuit falls below a voltage threshold value. The invention finds a particular application in devices for controlling the power supply of light sources and notably light-emitting diodes (LED).

The invention relates to the field of supplying electrical power, for example to light sources, to be more precise to light-emitting diodes (LED). In particular, the invention relates to a step-up/step-down type DC voltage converter and to a method of protecting such a converter if the supply of power to the converter fails.

It is known to use a DC voltage step-up converter circuit, for example of boost type, followed in series by a voltage step-down converter circuit, such as a buck circuit, in order to control the supply of power to a light source such as a light-emitting diode (LED). The boost and buck circuits are generally integrated circuits, and are activated and deactivated by an activation (“enable”) signal applied to one of the pins of the integrated circuit. A light-emitting diode (LED) is an electronic component capable of emitting light when an electric current is passed through it. The luminous intensity emitted by an LED is generally dependent on the intensity of the electric current through it. This is why it is important to control the electrical supply of power to LEDs. In the automotive field, LED technology is increasingly used for various illumination and/or signaling light solutions.

A control circuit including a boost-buck converter is used to control the current of a set or group of LEDs. The circuit defines the current that flows in a load branch and including the group of LEDs connected in series. It is known to use separate control circuits powering separate groups of LEDs, each group providing a separate lighting function of a motor vehicle. Such functions include inter alia high-beam, low-beam and side-lights.

It is known to connect a storage capacitor to the output of the boost converter. If the supply of power to the boost converter is cut off because of circumstances external to the converter, the capacitor can take over and supply power to the load temporarily. In the case of a load including LEDs, it is obvious that the voltage required for the correct operation of the LEDs cannot be provided for long by the charge on the capacitor before the latter is discharged completely.

It is also known to use a plurality of boost-buck conversion branches in parallel, each branch being supplied with power independently. The outputs of the boost circuits are then grouped and feed the storage capacitor. The buck circuits take electric charges from the store fed in this way by all the boost circuits of each branch. If the supply of power to one of the boost circuits fails, the other boost circuit or circuits can take over to supply power to all of the buck circuits. Each circuit is however limited to a maximum current that may be reached. The storage capacitor can then contribute to supplying power to the buck circuits as it discharges. Once the capacitor has been discharged, the load can no longer be supplied with power.

This kind of behavior is not acceptable in the field of supplying power to LEDs, and more particularly in the case of supplying power for a motor vehicle lighting function.

An objective of the invention is to propose a converter including protection means alleviating at least one of the disadvantages of the prior art. The invention also has the objective of proposing a device for controlling the supply of power to light sources, a lighting system for a motor vehicle using the control system according to the invention, and a method of protecting a boost-buck converter.

The invention consists in a voltage, notably DC voltage, converter device including at least one conversion branch including in series a voltage step-up circuit and a voltage step-down circuit, the step-down circuit being adapted to be activated or deactivated by an activation signal. The device includes means for activating the step-down circuit adapted to emit an activation signal. The activation means are preferably implemented by a microcontroller.

The device is noteworthy in that it further includes protection means connected to the input of the step-up circuit that prevent the activation of the step-down circuit if the measured input voltage of the step-up circuit is below a threshold value.

The protection means may preferably include a comparator that makes it possible to compare the measured input voltage of the step-up circuit to a threshold value and an “AND” logic circuit having as inputs the output of the comparator and the activation signal emitted by the activation means and the output signal of which is relayed to the step-down circuit to activate/deactivate it.

The threshold value may preferably be less than 6 V and more preferably equal to 5 V.

The protection means enable the activation of the step-down circuit only if the measured input voltage of the step-up circuit is below a threshold value for a predetermined time. If the measured input voltage of the step-up circuit is below the threshold value for a time shorter than the predetermined time, the voltage drop is filtered from the input signal. The predetermined time is preferably of the order of at least 1 ms.

The protection means may advantageously include an electronic filter configured to filter the measured input voltage of the step-up circuit before comparing it to said threshold value. If the measured input voltage of the step-up circuit is below the threshold value for a time shorter than the predetermined time, the voltage drop is filtered from the input signal.

The activation means and the protection means may preferably be provided by a single microcontroller.

The device may also include an electric charge storage element adapted to be charged by the step-up circuit when the latter is active.

The device may preferably include at least two conversion branches. Each branch includes protection means and the electrical charge storage element is adapted to be charged by the step-up circuit of each branch when the latter is active.

The storage element may preferably be a capacitor connected to the output of the step-up circuit.

The storage element may preferably be a capacitor connected to the common output of all the step-up circuits.

The voltage step-up circuit or circuits may preferably be boost type circuits. The voltage step-down circuit or circuits may preferably be buck type circuits.

The invention also consists in a device for controlling the supply of electrical power to at least one light source, the device including a DC voltage converter device noteworthy in that it is a device according to the invention.

The at least one light source may preferably be a light-emitting diode (LED).

The invention also consists in a motor vehicle lighting device including a device for controlling the supply of electrical power to at least one light source noteworthy in that it is a device according to the invention.

Finally, the invention also consists in a method of protecting a DC voltage converter. The method includes the following steps:
providing a DC voltage converter including at least one conversion branch including in series a voltage step-up circuit and a voltage step-down circuit, the step-down circuit being adapted to be activated or deactivated by an activation signal;
providing means for activation of the step-down circuit adapted to emit an activation signal;
protecting the step-down circuit by preventing its activation by protection means if the measured input voltage of the step-up circuit is below a threshold value.

The device and the method according to the invention make it possible to use known boost and buck conversion circuits in a DC voltage converter with the activation of the buck circuit or circuits dependent on the presence of a minimum voltage at the input of the relevant boost-buck branch. The protection circuit according to the invention makes it possible to deactivate a buck circuit quickly and in a controlled manner if a voltage drop is detected at the input of the corresponding boost circuit. The method may be implemented by an analog system using well-known electronic components or by a programmable microcontroller.

The solution according to the invention has multiple advantages compared to alternative solutions that might be envisaged. One alternative way to solve the problem of the loss of power supply to a buck circuit might be to use a storage capacitor of higher capacitance. However, such components are costly and occupy a large space on a printed circuit. It would also be possible to enable other boost circuits that take over from the unpowered boost circuit to consume more current in order to compensate the loss of one of the boost circuits. However, and especially in the automotive application, this would lead to the detection of a fault in the boost circuit that has taken over. This would therefore amount to the detection of a false positive.

Other features and advantages of the present invention will be better understood with the aid of the description and the drawings, which are provided by way of nonlimiting illustration of the invention only, and in which:

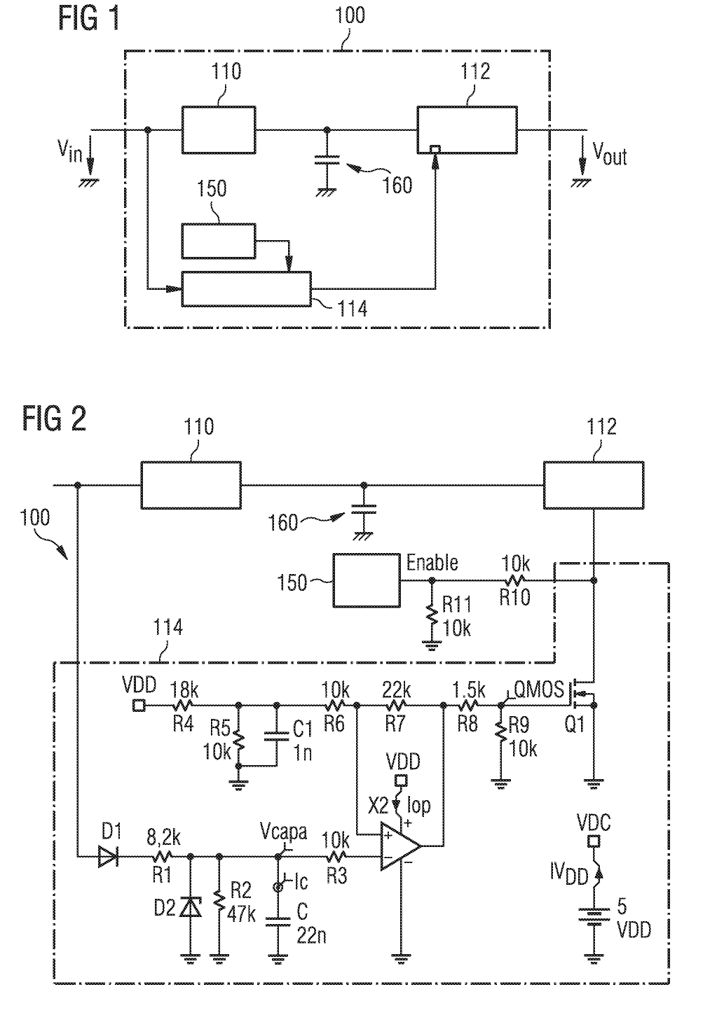

FIG. 1 is a diagrammatic illustration of one preferred embodiment of the device according to the invention;

FIG. 2 is a detailed diagrammatic illustration of one preferred embodiment of the device according to the invention;

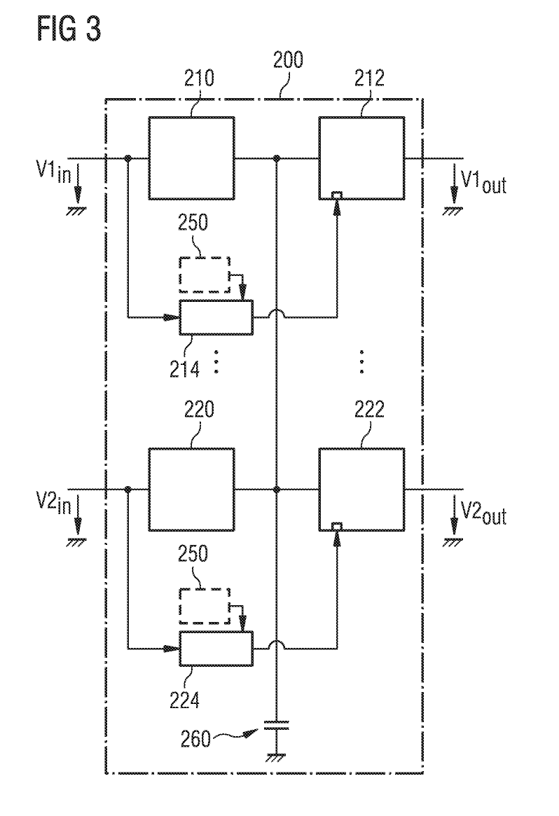

FIG. 3 is a diagrammatic illustration of one preferred embodiment of the device according to the invention.

Hereinafter, unless otherwise indicated, similar references will be used to describe similar concepts and/or similar means in different embodiments of the invention. For example, the references 100 and 200 will be used in describing three embodiments of the device according to the invention.

In the description of the invention, the term “boost circuit” is used by way of an example of a voltage step-up circuit. Similarly, the term “buck circuit” is used to describe a voltage step-down circuit. However, the invention is not limited to the use of boost and buck circuits, other voltage step-up and step-down circuits known in the art being similarly applicable.

One preferred embodiment of the invention is shown diagrammatically in FIG. 1. The device 100 makes it possible to convert a DC voltage Vin applied to the input into a DC output voltage Vout lower or higher than the input voltage. The output voltage is then applicable to a load circuit of the converter 100. The converter shown includes in series a boost voltage step-up circuit 110 and a buck voltage step-down circuit 112. Such circuits are known in themselves in the art and their operation will not be described in more detail in the context of the present description. The person skilled in the art will understand that a number of variants of known circuits can provide the boost function 110 and the buck function 112 described. In known manner, at least the buck circuit 112 can be activated/deactivated by an activation (“enable”) signal. The device 100 includes activation means 150 such as a microcontroller that make it possible to activate and to deactivate the buck (or boost) circuit according to predefined rules that govern the operation of the activation means. As a general rule, if the load of the converter 100 requires an electrical power supply, the activation means 150 are configured to activate the boost circuit and the buck circuit. The device 100 may also include a storage element, for example a storage capacitor 160, that is connected to the output of the boost circuit. When the latter is active, the capacitor is charged. In the case of application to a converter used in a motor vehicle, for example to power a lighting function thereof, the device 100 is supplied with power by a current source of the vehicle, to be more precise by the battery of the vehicle.

The device further includes protection means 114 connected to the input of the boost circuit 110 that prevent activation of the buck circuit 112 if the measured input voltage of the boost circuit is below a threshold value. The threshold value may be set by the person skilled in the art according to the target application of the converter 100. It may be below 6 V, for example, or equal to 5 V. The protection means 114 implement an “AND” logic gate. When the activation means have activated the buck circuit 112, a deactivation signal is sent to the buck circuit 112 if the input voltage of the boost circuit 110 falls below the threshold value. The latter circuit is activated only if the activation means are emitting an activation signal and at the same time the voltage at the input of the boost circuit 110 is above the threshold value.

In order to avoid activating the protection means 114 in the event of micro-interruptions of the input voltage, it is useful to provide a circuit for filtering the measured input voltage. The filter serves to eliminate these micro-interruptions, which can last of the order of one microsecond, in the measurement of the input voltage. In fact these micro-interruptions generally do not cause problems in supplying power to the circuit loading the device 100.

This describes generically the principle underlying the invention. Nonlimiting examples of implementation are illustrated by the embodiments described hereinafter.

FIG. 2 repeats the general structure shown in FIG. 1. A concrete example of the protection means 114 is shown in the form of an electrical circuit diagram. The measured input voltage is filtered by an RC circuit implementing a delay. A diode D1 is used to prevent any return of current. A zener diode D2 is used to guarantee a maximum logic level of 5 V for the detection function. The logic output of the comparator X2 defines a voltage that controls the MOSFET Q1. If the filtered voltage measurement is greater than 5 V, the MOSFET Q1 conducts and the resulting signal is combined with the “enable” signal from the activation means 150 to activate the buck circuit 112. If the filtered voltage measurement is below 5 V, the MOSFET Q1 is cut off and the combined signal becomes a signal for deactivating the buck circuit 112.

FIG. 3 shows diagrammatically another preferred embodiment of the invention. The converter 200 includes a plurality of conversion branches connected in parallel. Each branch shown includes in series a boost circuit 210, 220 and a buck circuit 212, 222. The device 200 includes activation means 250 such as a microcontroller that make it possible to activate and to deactivate the buck (or boost) circuit or circuits according to predefined rules that govern the operation of the activation means. The activation means 250 are preferably common to all the buck circuits 212, 222 of the device 200. The device 200 may also include a storage element, for example a storage capacitor 260, that is connected to the common output of the boost circuits 210, 220.

The device includes protection means 214, 224 for each of the boost-buck branches. The means 214 are connected to the input of the boost circuit 210 and prevent activation of the buck circuit 212 if the measured input voltage of the boost circuit 210 is below a threshold value. In an analogous manner, the means 224 are connected to the input of the boost circuit 220 and prevent activation of the buck circuit 222 if the measured input voltage of the boost circuit 220 is below a threshold value.

The threshold value for each branch of the converter 200 can be set by the person skilled in the art according to the target application. The operation of the protection means 214, 224 is similar to the operation described for the embodiments illustrated by FIGS. 1 and 2.

With the aid of the description that has been given, the person skilled in the art will know how to modify the electronic circuits described and to create alternative circuits implementing similar functions without this departing from the scope of the present invention. Features described for one embodiment may be combined with those of other embodiments unless there is an explicit indication to the contrary.

1. A voltage, notably DC voltage, converter device comprising:
at least one conversion branch including in series a voltage step-up circuit and a voltage step-down circuit, said voltage step-down circuit being adapted to be activated or deactivated by an activation signal, and
means for activating said voltage step-down circuit adapted to emit said activation signal,
wherein said device further includes protection means connected to an input of said voltage step-up circuit that prevent an activation of said voltage step-down circuit if the measured input voltage of said voltage step-up circuit is below a threshold value.

2. The device as claimed in claim 1, wherein said protection means include:
a comparator element that makes it possible to compare the measured input voltage of said voltage step-up circuit to a threshold value, and
a logic “AND” circuit having as inputs an output of said comparator element and said activation signal emitted by said activation means and an output signal of which is relayed to said voltage step-down circuit to activate/deactivate it.

3. The device as claimed in claim 1, in which said threshold value is less than 6 V and preferably equal to 5 V.

4. The device as claimed in claim 1, wherein said protection means enable the activation of the step-down circuit only if the measured input voltage of said voltage step-up circuit is below said threshold value for a predetermined time.

5. The device as claimed in claim 4, wherein said protection means include an electronic filter configured to filter the measured input voltage of said voltage step-up circuit before comparing it to said threshold value.

6. The device as claimed in claim 1, wherein said activation means and said protection means are provided by a single microcontroller.

7. The device as claimed in claim 1, wherein said device includes an electric charge storage element adapted to be charged by said voltage step-up circuit when the latter is active.

8. The device as claimed in claim 1, wherein said device includes at least two conversion branches, each branch including protection means and an electric charge storage element being adapted to be charged by said voltage step-up circuit of each branch when the latter is active.

9. The device as claimed in claim 7, wherein said electric charge storage element is a capacitor.

10. The device as claimed in claim 1, wherein said voltage step-up circuit or circuits is or are boost circuits and/or in which said voltage step-down circuit or circuits is or are buck circuits.

11. The device for controlling the electrical power supply of at least one light source, said device including a DC voltage converter device, wherein said converter device is a device as claimed in claim 1.

12. The device as claimed in claim 11, in which said at least one light source is a light-emitting diode (LED).

13. A motor vehicle lighting device including a device for controlling the supply of electrical power to at least one light source, wherein said control device is a device as claimed in claim 11.

14. A method of protecting a DC voltage converter comprising the following steps:
providing a DC voltage converter including at least one conversion branch including in series a voltage step-up circuit and a voltage step-down circuit, said voltage step-down circuit being adapted to be activated or deactivated by an activation signal;
providing means for activation of said voltage step-down circuit adapted to emit an activation signal;
protecting said voltage step-down circuit by preventing its activation by protection means if the measured input voltage of said voltage step-up circuit is below a threshold value.

15. The device as claimed in claim 2, in which said threshold value is less than 6 V and preferably equal to 5 V.

16. The device as claimed in claim 2, wherein said protection means enable the activation of the step-down circuit only if the measured input voltage of said voltage step-up circuit is below said threshold value for a predetermined time.

17. The device as claimed in claim 3, wherein said protection means enable the activation of the step-down circuit only if the measured input voltage of said voltage step-up circuit is below said threshold value for a predetermined time.

18. The device as claimed in claim 2, wherein said activation means and said protection means are provided by a single microcontroller.

19. The device as claimed in claim 3, wherein said activation means and said protection means are provided by a single microcontroller.

20. The device as claimed in claim 3, wherein said device includes an electric charge storage element adapted to be charged by said voltage step-up circuit when the latter is active.
